(19) United States
(12) Patent Application Publication
(10) Pub. No.: US 2026/0153476 A1
(43) Pub. Date: Jun. 4, 2026

(54) MEMBRANE TRANSFER CASSETTE

(71) Applicant: Global Life Sciences Solutions Operations UK LTD, Sheffield (GB)

(72) Inventors: Andrew Hamilton, Uppsala (SE); Alejandra Hortua Diaz, Uppsala (SE); Rodrigo Hermandez Vera, Uppsala (SE); Kjell Larsson, Uppsala (SE); Erik Nilsson, Uppsala (SE)

(21) Appl. No.: 18/279,367

(22) PCT Filed: Mar. 17, 2022
(86) PCT No.: PCT/EP2022/056987

§ 371 Date: Aug. 29, 2023

(30) Foreign Application Priority Data
Mar. 19, 2021 (GB) 2103879.9

(51) Int. Cl. G01N 27/447; B01D 57/02

(52) U.S. Cl. CPC G01N 27/44739; B01D 57/02

(57) ABSTRACT

Provided is a membrane transfer cassette for electroblotting, the cassette comprising a first support panel and a second support panel, at least a region of one or each of the first and second support panels having an interlocking pattern of polygonal apertures. The membrane transfer cassette is particularly useful when electroblotting with large format gels as the design of the cassette increases the exposed surface area between the gel and the membrane while also enhancing the strength of the cassette to support large gels but is also advantageous for any size of gel.

### FIELD

The present disclosure relates to a membrane transfer cassette for electroblotting, a support panel for a membrane transfer cassette for electroblotting, a computer-aided design file comprising a digital representation of a support panel for a membrane transfer cassette for electroblotting or a membrane transfer cassette, an electroblotting kit and a method of electroblotting.

### BACKGROUND

It is a common practice in biological experimentation to separate macromolecules such as proteins and nucleic acids, e.g., DNA or RNA, for analytical and preparative purposes using electrophoresis. Electrophoresis separates biomolecules by charge and/or size via mobility through a separating matrix, such as a gel separating matrix, in the presence of an electric field. Gel separating matrices are typically prepared from agarose for nucleic acid separation and polyacrylamide for protein separation. In capillary electrophoresis, the matrices may be gels or solutions (e.g., linear polyacrylamide solution).

The field induces charged materials, such as nucleic acids and proteins, to migrate toward respective anode or cathode positions.

The migration distances for the separated molecular species depend on their relative mobility through the separating matrix. Mobility of each species depends on hydrodynamic size and molecular charge.

Blotting is a process used to transfer macromolecules from an electrophoresis matrix to a membrane for further analysis. Examples of blotting include Southern, Northern, or Western blotting. Traditionally, the separating matrix containing the electrophoresed biological material is removed from the electrophoresis apparatus and placed in a blotting sandwich. The blotting sandwich typically consists of buffer saturated sponges and paper pads; a gel containing the separated biologicals; a suitable transfer membrane that is in intimate contact with the separating matrix; and another layer of buffer saturated paper pads and sponges. In electroblotting, the blotting sandwich may be immersed in buffer and suspended between two electrodes to provide an electric field to move the biologicals out of the separating matrix and into the membrane. This is known as a wet transfer protocol.

Electrophoretic separation on large format gels, e.g., greater than about 20 cm by 20 cm, can greatly improve long range protein separation with maximum resolution. However, the advantages of increased resolution resulting from large format gels is typically offset by the difficulties encountered in handling such large gels in conventional systems. For any size blotting sandwich, and particularly for large format gels, it is important to ensure good contact between the separating matrix and membrane. To achieve this, a membrane transfer cassette is used. The blotting sandwich is placed between two panels of the cassette and the elements of the blotting sandwich are held in place during transfer of the macromolecules from the separating matrix onto the membrane. However, the separating matrix must also be exposed to the current to allow for the transfer of the macromolecules from the separating matrix to the membrane. This is achieved by use of a membrane transfer cassette with a number of apertures in the panels in order to expose the separating matrix. However, these apertures compromise the strength of the membrane transfer cassette. Accordingly, an improved membrane transfer cassette is required.

### SUMMARY

This summary introduces concepts that are described in more detail in the detailed description. It should not be used to identify essential features of the claimed subject matter, nor to limit the scope of the claimed subject matter.

In a first aspect there is provided a membrane transfer cassette for electroblotting. The cassette comprises a first support panel and a second support panel. At least a region of one or each of the first and second support panels has an interlocking pattern of polygonal apertures and the polygonal apertures have 3 sides or 5 or more sides.

A membrane transfer cassette is thus provided for supporting a blotting sandwich during an electroblotting process. Advantageously, a membrane transfer cassette which is strong enough to maintain close contact between the membrane and the separating matrix to allow for effective and even transfer of the macromolecules from the separating matrix to the membrane can be provided. Another benefit of the membrane transfer cassette is that a significant proportion of the surface area of the support panel over which the interlocking pattern of polygonal apertures is arranged is taken up by the apertures. The separating matrix is therefore exposed to the current (and not blocked by the cassette) over a significant proportion of the surface area. A large proportion of the separating matrix is thus exposed to the current which allows more even and efficient application of current and thus more even transfer of macromolecules from the separating matrix to the membrane. These advantages are of particular use in large format separating matrices (or large format gels), exemplary sizes of which are provided below, but find use in wet transfer protocols for separating matrices of any size.

As mentioned above, the polygonal apertures have 3 sides or 5 or more sides. In other words, each of the polygonal apertures may be a triangle, a pentagon or a polygon with a number of sides greater than five. Various combinations of polygons are envisaged and the polygonal apertures are not necessarily all of the same shape. In some embodiments the polygonal apertures are not squares. In some embodiments the polygonal apertures are not squares or rectangles.

As stated above, the polygonal apertures are not necessarily of the same shape and instead the polygonal apertures may comprise apertures having two or more shapes. Equally, each of the polygonal apertures may have the same shape.

The polygonal apertures may comprise apertures of two or more sizes. For example, the polygonal apertures may comprise apertures having different areas. In this way, apertures having different shapes and/or sizes can be combined to provide an interlocking pattern of polygonal apertures. Control over the percentage surface area of exposed separating matrix and the strength of the support panel (or region of support panel) is thus facilitated.

Each of the polygonal apertures may be a hexagon and the interlocking pattern may be a honeycomb pattern. The honeycomb pattern results in a particularly strong support panel which provides particularly good contact between the separating matrix and the membrane, resulting in effective and even transfer of the macromolecules from the separating matrix to the membrane. Another benefit of the honeycomb pattern and use of hexagonal apertures is that the support panel is strong whilst allowing a significant proportion of the separating matrix to be exposed. In other words, there is a particularly good trade-off between the strength of the support panel and the proportion of separating matrix that is exposed.

Other shapes of aperture are also envisaged. Some or each of the polygonal apertures may be a hexagon with rounded edges or a dodecagon, for example.

The membrane transfer cassette typically has the following features:
the first support panel may have an inner surface and an outer surface; and
the second support panel may have an inner surface and an outer surface.

In use, the inner surface of the first support panel faces the inner surface of the second support panel. Each polygonal aperture may be separated from each adjacent aperture by a respective wall. One or more of the walls may have a surface area on the outer surface of the support panel which is greater than a surface area of the wall on the inner surface of the support panel. In other words, one or more walls between apertures may be thicker on an outside surface of the support panel as compared to an inside surface of the support panel. This reduces the surface area of the support panel which is in contact with the blotting sandwich even further, whilst maintaining strength in the support panel by virtue of the larger surface area of the walls on the outside surface of the support panel. This reduction in the surface area over which the support panel is in contact with the blotting sandwich reduces the number of macromolecules in the gel that are blocked from transferring to the membrane. The result is a more even and accurate transfer of the macromolecules to the membrane which more accurately represents the position of said macromolecules in the gel. This facilitates a more accurate measurement of the macromolecules. This reduction in the surface area over which the support panel is in contact with the blotting sandwich also means that the cassette is pressing on the membrane over a smaller surface area and this can result in more accurate measurements of the macromolecules on the membrane as a result of a more even background.

The cross-section of such a wall may be triangular or trapezoidal. In this sense, the walls may taper from a first width on an outer face of the support panel to a second, smaller, width on an inner face of the support panel. Alternatively, the walls may not taper and instead there may be a step-change in width of the walls between the outer face of the support panel and the inner face of the support panel. Alternatively, the cross-section of such a wall could be a semicircle.

As mentioned above, at least a region of one or each of the first and second support panels has an interlocking pattern of polygonal apertures. This region may be a central region of the respective support panel and the respective support panel may further comprise an outer region having apertures. The apertures in the outer region may differ in one or more of shape, size or pattern to the polygonal apertures in the central region. In this way, a central region of the support panel may comprise a plurality of polygonal apertures arranged in an interlocking pattern and an outer region of the support panel may comprise apertures having different size, shape and/or pattern to those in the central region. The benefit of this is that the features of the apertures in the central region (and/or the walls separating them) may be chosen in order to make the centre of the support panel particularly strong. This is advantageous because generally, it is over the central region of a blotting sandwich where the contact between the separating matrix and membrane is poorest due to bowing of the support panels. This effect is exacerbated in large-format gels.

Alternatively, the region which has an interlocking pattern of polygonal apertures may be an outer region of the respective support panel and the respective support panel may further comprise a central region having apertures. The apertures in the central region may differ in one or more of shape, size or pattern to the polygonal apertures in the outer region. Of course, both the central region and the outer region may have an interlocking pattern of polygonal apertures (either the same pattern or different patterns) but one or more of shape, size and pattern may differ between the central and outer regions.

In any of these configurations, the apertures in the central region may be smaller than the apertures in the outer region. This may increase the strength of the central region.

Alternatively or additionally, the apertures in the central region may be hexagons and may form a honeycomb pattern. Again, this may increase the strength of the central region.

In addition to or as an alternative to a difference in one or more of shape, size or pattern as between the apertures of the central region and the apertures of the outer region, one or more characteristics of respective walls between the apertures of the central region may be different to those of respective walls between the apertures of the outer region. For example, the walls between the apertures of the central region may be thicker (in the plane of the support panel and/or in a direction perpendicular to the plane of the support panel) than the walls between the apertures of the outer region.

In a second aspect there is provided a membrane transfer cassette for use in electroblotting. The cassette comprises a first support panel having an inner surface and an outer surface and a second support panel having an inner surface and an outer surface. In use, the inner surface of the first support panel faces the inner surface of the second support panel. One or each of the first and second support panels has a set of apertures and each aperture is separated from each adjacent aperture by a respective wall. One or more of the walls has a surface area on an outer surface of the support panel which is greater than a surface area of the wall on an inner surface of the support panel.

This concept was described above with reference to the interlocking pattern of polygonal apertures but it will be appreciated that the concept is not limited to this feature.

As described above, one or more walls between apertures may be thicker on an outside surface of the support panel as compared to an inside surface of the support panel. This reduces the surface area of the support panel which is in contact with the blotting sandwich even further, whilst maintaining strength in the support panel by virtue of the larger surface area of the walls on the outside surface of the support panel.

At least some of the set of apertures may be polygonal apertures which form an interlocking pattern. As described above, such a pattern of apertures results in a support panel which is strong enough to maintain close contact between the membrane and the separating matrix whilst also allowing a large enough proportion of the separating matrix to be exposed (as opposed to being blocked by walls between the apertures). Both factors facilitate the effective and even transfer of the macromolecules from the separating matrix to the membrane.

The set of apertures may comprise apertures of two or more shapes or alternatively, each of the apertures may be the same shape.

The set of apertures may comprise apertures of two or more sizes. As above, the various combinations of size and/or shape of aperture facilitate the provision of control over the specific characteristics of the support panel or a region of the support panel.

In the case that at least some of the set of apertures may be polygonal apertures, each of the polygonal apertures may have 3 sides or 5 or more sides.

Each of the polygonal apertures may be a hexagon and the interlocking pattern may be a honeycomb pattern. As mentioned above, the honeycomb pattern results in a particularly strong support panel which provides for effective and even transfer of the macromolecules from the separating matrix to the membrane.

One or each of the first and second panels may comprise a central region comprising an inner plurality of apertures and an outer region comprising an outer plurality of apertures. The set of apertures may comprise at least some of the inner and/or outer plurality of apertures. The apertures of the inner plurality of apertures may differ in one or more of shape, size or pattern to the apertures of the outer plurality of apertures. The effect of this is that different regions of a support panel may have different characteristics. These characteristics may be strength, for example, or the proportion of the surface area of the support panel which is taken up by the apertures (as opposed to the walls between the apertures). For example, a central region of the support panel could have a first configuration of apertures which increases the strength of that central region but results in a smaller proportion of the surface area being taken up by apertures over that central region (resulting in less exposed separating matrix). An outer region of the support panel could have a different configuration of apertures which is, for example, not as strong as the central region but results in a greater proportion of the separating matrix being exposed. The trade-off between separating matrix exposure and strength can thus be tuned differently for different regions of the support panel where different problems exist.

In addition to or as an alternative to a difference in one or more of shape, size or pattern as between the apertures of the central region and the apertures of the outer region, one or more characteristics of respective walls between the apertures of the central region may be different to those of respective walls between the apertures of the outer region. For example, the walls between the apertures of the central region may be thicker (in the plane of the support panel and/or in a direction perpendicular to the plane of the support panel) that the walls between the apertures of the outer region.

In a third aspect there is provided a membrane transfer cassette for use in electroblotting. The cassette comprises a first support panel and a second support panel. One or each of the first and second panels comprises a central region having an inner plurality of apertures and an outer region having an outer plurality of apertures. The apertures of the inner plurality of apertures differ in one or more of shape, size or pattern to the apertures of the outer plurality of apertures.

This concept is described above and it will be appreciated that although it is not limited to any of the features described above, the advantages of this concept described above apply here.

In addition to or as an alternative to a difference in one or more of shape, size or pattern as between the apertures of the inner plurality of apertures and the apertures of the outer plurality of apertures, one or more characteristics of respective walls between the apertures of the inner plurality of apertures may be different to those of respective walls between the apertures of the outer plurality of apertures. For example, the walls between the apertures of the inner plurality of apertures may be thicker (in the plane of the support panel and/or in a direction perpendicular to the plane of the support panel) than the walls between the apertures of the outer plurality of apertures.

In any of the cassettes described herein, the apertures in the inner plurality of apertures may be smaller than the apertures in the outer plurality of apertures. This may strengthen the central region and reduce the risk of the support panel bowing, resulting in poor contact between the separating matrix and the membrane.

Alternatively or additionally, the inner and/or outer plurality of apertures may each comprise apertures of two or more different shapes and/or sizes.

Each of the inner plurality of apertures and/or each of the outer plurality of apertures may have the same shape and/or size.

Each of the apertures in the inner and/or outer plurality of apertures may be hexagons and may form a honeycomb pattern. As described above, the honeycomb configuration of hexagons provided a strong support panel whilst still exposing a significant proportion of the separating matrix.

At least some of the inner and/or outer plurality of apertures may be polygonal and may form an interlocking pattern. Each of the polygonal apertures may have 3 sides or 5 or more sides.

Each of the polygonal apertures may be a hexagon and the interlocking pattern may be a honeycomb pattern.

The first support panel may have an inner surface and an outer surface and the second support panel may have an inner surface and an outer surface. In use, the inner surface of the first support panel faces the inner surface of the second support panel. Each aperture of the set of apertures may be separated from each adjacent aperture by a respective wall. One or more of the walls may have a surface area on an outer surface of the support panel which is greater than a surface area of the wall on an inner surface of the support panel. In other words, one or more walls between apertures may be thicker (in the plane of the support panel) on an outside surface of the support panel as compared to an inside surface of the support panel. This reduces the surface area of the support panel which is in contact with the blotting sandwich even further, whilst maintaining strength in the support panel by virtue of the larger surface area of the walls on the outside surface of the support panel.

The cross-section of such a wall may be triangular or trapezoidal. In this sense, the walls taper from a first width on an outer face of the support panel to a second, smaller, width on an inner face of the support panel. Alternatively, the walls may not taper and instead there may be a step-change in width of the walls between the outer face of the support panel and the inner face of the support panel. Alternatively, the cross-section of such a wall could be a semicircle.

In any of the membrane transfer cassettes described herein, one or each of the first and second support panels may be bowed. In particular, one or each of the first and second support panels may be bowed inwards. Specifically, the first and second support panels may have an inner surface and an outer surface, wherein when the membrane transfer cassette is in use, the inner surface of the first support panel faces the inner surface of the second support panel. One or both of the support panels may be bowed inwards such that, in the absence of the blotting sandwich, when the inner surfaces of the first and second support panels face each other, a distance between the centre of the first support panel and the centre of the second support panel is less than a distance between the first and second support panels at an edge of the support panels.

The result of this bowing is that in use, the pressure exerted by the membrane transfer cassette on the blotting sandwich is more uniform over the plane of the membrane transfer cassette. This is because the bowing compensates for the reduced strength of the support panel at the centre as compared to the edges.

One of the first and second support panels may be flat and the other support panel may be bowed in this way. An advantage of this arrangement is that the blotting sandwich can be prepared on top of the flat support panel (by placing each layer of the blotting sandwich on top of the flat support panel in turn) and the other panel, which may not be flat, can be placed on top.

In a fourth aspect there is provided a membrane transfer cassette for electroblotting, the cassette comprising a first support panel and a second support panel, at least a region of one or each of the first and second support panels having a plurality of apertures, wherein one or each of the first and second support panels is bowed. Specifically, the first and second support panels may have an inner surface and an outer surface, wherein when the membrane transfer cassette is in use, the inner surface of the first support panel faces the inner surface of the second support panel. One or both of the support panels may be bowed inwards such that, in the absence of the blotting sandwich, when the inner surfaces of the first and second support panels face each other, a distance between the centre of the first support panel and the centre of the second support panel is less than a distance between the first and second support panels at an edge of the support panels.

As described above, the result of this bowing is that in use, the pressure exerted by the membrane transfer cassette on the blotting sandwich is more uniform over the plane of the membrane transfer cassette. This is because the bowing compensates for the reduced strength of the support panel at the centre as compared to the edges

The plurality of apertures may comprise apertures having two or more shapes. Equally, each of the apertures may be the same shape. The plurality of apertures may comprise apertures of two or more sizes.

The apertures may be polygonal and form an interlocking pattern. Each of the polygonal apertures may have 3 sides or 5 or more sides.

Each of the polygonal apertures may be a hexagon and the interlocking pattern may be a honeycomb pattern.

The first support panel may have an inner surface and an outer surface and the second support panel may have an inner surface and an outer surface. In use, the inner surface of the first support panel faces the inner surface of the second support panel. Each aperture may be separated from each adjacent aperture by a respective wall. One or more of the walls may have a surface area on the outer surface of the support panel which is greater than a surface area of the wall on the inner surface of the support panel.

As mentioned above, at least a region of one or each of the first and second support panels has a plurality of apertures. The region may be a central region of the respective support panel and the respective support panel may further comprise an outer region having apertures, where the apertures in the outer region differ in one or more of shape, size or pattern to the apertures in the central region.

Alternatively, the region may be an outer region of the respective support panel and the respective support panel may further comprise a central region having apertures, where the apertures in the central region differ in one or more of shape, size or pattern to the apertures in the outer region.

The apertures in the central region may be smaller than the apertures in the outer region.

The apertures in the central region may be hexagons and may form a honeycomb pattern.

In any of the cassettes described herein, one or each of the first and second support panels may comprise a connecting mechanism for connecting the first and second support panels together. One of the first and second support panels may be flat and the other support panel may comprise a connecting mechanism for connecting the first and second support panels together.

The connecting mechanism may be a hinged clip for connecting the first and second support panels together. The hinged clip may be arranged at an edge of the support panel, for example a top edge of the membrane transfer cassette (i.e. the uppermost edge when the membrane transfer cassette is in use). When the hinged clip is in use, the hinged clip may span 60% or more or more or preferably 70% or more of the length of the edge of the panel. When the hinged clip, in use, spans the majority of the width of the membrane transfer cassette in this way, the hinged clip helps strengthen the membrane transfer cassette and reduce bowing of the support panels. In use, the hinged clip may be arranged to fit over the first and second support panels and the blotting sandwich in order to hold them together.

The hinged clip may have a raised portion (i.e. a region of increased thickness) at the end of the clip where the hinge is located. This is to increase the strength of the clip at the hinge location.

Alternatively or additionally, one or both of the support panels may comprise an integral clip at an edge of the support panel. The integral clip is integral to the support panel and, in use, is arranged to receive the other support panel and the blotting sandwich.

The integral clip may have a first portion extending perpendicular to the plane of the support panel and a second portion extending parallel to the plane of the support panel, facing the support panel.

As mentioned above, the integral clip is disposed at an edge of the respective support panel. Where the membrane transfer cassette also comprises a hinged clip, the integral clip and the hinged clip may be disposed at opposite edges of the membrane transfer cassette or, where the hinged clip and integral clip are disposed on the same support panel, the support panel.

The integral clip may be as long, or substantially as long, as the edge of the support panel at which it is disposed. This is advantageous because the integral clip aids in strengthening the support panel and the membrane transfer cassette as a whole, helping to prevent bowing of the support panel and cassette during use and thus facilitating good contact between the separating matrix and the membrane.

Both the first and second support panels may have an integral clip such as that described above. Each integral clip may interlock with the other support panel to compress the blotting sandwich between the support panels when in use.

Alternatively, one of the first and second support panels may comprise an integral clip and the other support panel may comprise a hinged clip. Alternatively, one of the first and second support panels may comprise both an integral clip and a hinged clip. In the latter case, the other support panel may be flat.

The integral clip may comprise two retaining elements, one at each end of the integral clip and facing each other. In use, at least a portion of the blotting sandwich and/or at least a portion of the bottom edge of the other support panel may sit in between the two retaining elements. The retaining elements may aid in aligning the two support panels and the blotting sandwich between them when the cassette is in use and may reduce the risk of any of the layers of the blotting sandwich and the other support panel moving relative to the support panel on which the integral clip is disposed.

In any support panel described herein, the percentage of the surface area of the first and/or second support panels which is taken up by apertures may be between 55% and 75% or preferably between 65% and 75%.

In any membrane transfer cassette described herein, the membrane transfer cassette may comprise one or more support rods. Such support rods may help reduce bowing of the support panels in use and help provide close contact between the separating matrix and the membrane. One or more rods may be integral to one or each of the first and second support panels or may be separate, attached to the respective support panel by a suitable means, such as adhesion, clips or other securing means. One or each of the first and second support panels may comprise support rods which span the width of the respective support panel. The rods may be thinner (in a direction perpendicular to the plane of the panel) than the support panel itself such that in use, the support rods do not come into contact with the blotting sandwich. In this way, the rods may strengthen the support panel but do not increase the surface area of the panel which contacts the blotting sandwich during use. The support rods may equally have a different configuration (for example they could run from the top to the bottom of the support panel as opposed to from one side to the other). The support rods may not necessarily be parallel but could overlap. For example, one set of support rods may run perpendicular to another set.

In any membrane transfer cassette disclosed herein, the first support panel may be a different colour to the second support panel. This allows the user to orient the cassette correctly with respect to the electrodes so that the macromolecules are attracted in the right direction (i.e. onto the membrane and not back out the other side of the separating matrix).

In any membrane transfer cassette disclosed herein, the apertures on the first support panel could be the same as those on the second support panel, specifically in terms of size and shape. In other words, the apertures of the first support panel may line up with the apertures of the second support panel. Equally, they may not line up and the size and/or shape of the apertures may differ between the first and second support panels.

As mentioned above, the benefits of the membrane transfer cassette disclosed herein are particularly relevant to large format gels (separating matrices). Examples of the gel sizes to be used with the membrane transfer cassette as disclosed herein are as follows;

$$25.5 \times 19.2 cm ( DIGE gels )$$

$$25 \times 25.5 cm$$

$$20 \times 20 cm$$

$$18.5 \times 20 cm$$

$$16 \times 20 cm$$

$$16 \times 16 cm$$

The membrane transfer cassettes could also be used with 30×25 cm gels, or scaled down to 14×9 cm or even 8×7 cm gels (though the advantages of increased stability would be less at smaller gel sizes). In summary the cassettes disclosed herein are envisioned to be used with gels with dimensions ranging from around 7 cm to around 26 cm and would be particularly useful for gels with a dimension of around 15 cm or greater. However, it will be appreciated that the cassettes and methods disclosed herein could be used with any size gel.

In a fifth aspect there is provided a support panel for a membrane transfer cassette for electroblotting, at least a region of the support panel having an interlocking pattern of polygonal apertures. The support panel may optionally comprise any of the features described herein. For example, the polygonal apertures of the support panel may have 3 sides or 5 or more sides. The polygonal apertures may not necessarily be of the same shape. For example, the polygonal apertures may comprise two or more shapes. Equally, the polygonal apertures may each have the same shape.

The membrane transfer cassette or any part of it or the support panel for a membrane transfer cassette may be made by additive manufacture (3D printing). The use of additive manufacture allows for more intricate designs that may increase the stability and/or strength of the support panel(s) and/or a reduced contact area of the support panel(s) with the blotting sandwich (e.g. by way of the smaller surface area of the walls separating the apertures on the inside of the cassette as opposed to the outside). It also reduces the cost of manufacture at low volumes. An example of a suitable material is polyamide 12, which is lightweight and improves usability. It also offers chemical resistance to the buffers used and voltages applied in wet-transfer electroblotting.

In a sixth aspect there is provided a computer-aided design file comprising a digital representation of a support panel as described herein or of a membrane transfer cassette as described herein. The computer-aided design file is readable by an additive manufacturing device such as a 3D printer for the device to produce the components of the membrane transfer cassette or support panel by additive manufacture.

The membrane transfer cassette or any part of it could also be machined or made by injection moulding.

In a seventh aspect there is provided an electroblotting kit. The kit comprises at least a membrane transfer cassette as described herein and one or more elements of an electroblotting sandwich.

Herein, the stack of layers used in the electroblotting process and sandwiched between the first and second support panels is referred to as the blotting sandwich or electroblotting sandwich. The blotting sandwich (or electroblotting sandwich) may comprise one or more of the following, in addition to a separating matrix and a membrane:
one or more sponges or fibre pads and
one or more pieces of filter paper.

For example, the blotting sandwich may comprise at least the following elements, in the following order:
A sponge or fibre pad
One or more pieces of filter paper
The membrane
The separating matrix
One or more pieces of filter paper and
A sponge or fibre pad.

In an eighth aspect there is provided a method of electroblotting comprising using a membrane transfer cassette as described herein.

There is also provided a membrane transfer cassette for electroblotting. The cassette comprises a first support panel and a second support panel, at least a region of one or each of the first and second support panels having an interlocking pattern of polygonal apertures.

Each of the polygonal apertures may have 3 sides or 5 or more sides.

The polygonal apertures may comprise apertures having two or more shapes. Equally, each of the polygonal apertures may be the same shape.

The polygonal apertures may comprise apertures of two or more sizes.

Each of the polygonal apertures may be a hexagon and the interlocking pattern may be a honeycomb pattern.

The membrane transfer cassette typically has the following features:
the first support panel has an inner surface and an outer surface; and
the second support panel has an inner surface and an outer surface.

In use, the inner surface of the first support panel faces the inner surface of the second support panel and each polygonal aperture is separated from each adjacent aperture by a respective wall.

One or more of the walls may have a surface area on the outer surface of the support panel which is greater than a surface area of the wall on the inner surface of the support panel.

As mentioned above, at least a region of one or each of the first and second support panels may have an interlocking pattern of polygonal apertures. The region may be a central region of the respective support panel and the respective support panel may further comprise an outer region having apertures, wherein the apertures in the outer region differ in one or more of shape, size or pattern to the polygonal apertures in the central region.

Alternatively, the region may be an outer region of the respective support panel and the respective support panel may further comprise a central region having apertures, wherein the apertures in the central region differ in one or more of shape, size or pattern to the polygonal apertures in the outer region.

The apertures in the central region may be smaller than the apertures in the outer region.

The apertures in the central region may be hexagons and may form a honeycomb pattern.

One or each of the first and second support panels may be bowed.

One of the first and second support panels may be flat and the other support panel may comprise a connecting mechanism for connecting the first and second support panels together.

The connecting mechanism may be a hinged clip for connecting the first and second support panels together. The hinged clip may be arranged at an edge of the support panel and the length of the hinged clip may be 60% or more or preferably 70% or more of the length of the edge of the panel.

The percentage of the surface area of the first and/or second support panels which is taken up by apertures may be between 55% and 75% or preferably between 65% and 75%.

One of the first and second support panels may comprise an integral clip at an edge of the support panel, wherein the integral clip is integral to the support panel and is arranged to receive the other support panel.

The integral clip may be as long as the length of the edge of the panel.

There is also provided a support panel for a membrane transfer cassette for electroblotting, at least a region of the support panel having an interlocking pattern of polygonal apertures.

There is also provided a computer-aided design file comprising a digital representation of the support panel as described herein or the membrane transfer cassette as described herein, wherein the computer-aided design file is readable by an additive manufacturing device such as a 3D printer for the device to produce the components of the membrane transfer cassette or support panel by additive manufacture.

There is also provided an electroblotting kit, the kit comprising at least a membrane transfer cassette as described herein and one or more elements of an electroblotting sandwich.

There is also provided a method of electroblotting comprising using a membrane transfer cassette as described herein.

For any of the cassettes disclosed herein the first support panel may mirror the second support panel, in that the first and second support panels may have the same shape, size and configuration of apertures and may have support frames of the same dimensions. Alternatively, any aspect of the first or second support panel may differ from the other support panel.

In any of the membrane transfer cassettes or support panels disclosed herein, one or each of the support panels may comprise a groove on one of its edges, for example one or more side edges (i.e. the edges at the sides of the panel when it is in use). Such a groove is a region of reduced thickness along an edge of the support panel. These grooves are present to facilitate the use of otherwise thicker support panels in a given transfer tank which is configured to receive a cassette (including the blotting sandwich) of a given thickness. By reducing the thickness of the support panel at the edges, for example at the side edges, the rest of the support panel can be made thicker than it otherwise could be, whilst still ensuring that the cassette will fit into a slot in the transfer tank. This increased thickness over other regions of the support panel makes the support panel stronger and reduces bowing.

In general, a thicker support panel is preferable for increased strength but the thickness of the support panel will be limited by the thickness that will be accepted by the transfer tank.

In any of the membrane transfer cassettes and/or support panels disclosed herein, a thickness of the walls between apertures (in the plane of the support panel) may preferably be approximately 3 to 3.5 mm (in the plane of the support panel). Such narrow walls increase the surface area of the blotting sandwich which is exposed to the buffer by reducing the surface area over which the support panel is in contact with the blotting sandwich. This means that a greater proportion of the macromolecules are transferred from the gel to the membrane, resulting in a more even and accurate representation of the position of the macromolecules in the gel. This reduction in the surface area over which the support panel is in contact with the blotting sandwich also means that the cassette is pressing on the membrane over a smaller surface area and this can result in more accurate measurements of the macromolecules on the membrane as a result of a more even background.

In any support panel described herein, one or more apertures at an edge of the support panel may be a partial aperture. This use of partial apertures increases the exposure of the separating matrix at the edges of the support panel.

The term ‘membrane transfer cassette’ has been used herein but such a cassette may equally be referred to simply as a ‘cassette’ or an ‘electroblotting cassette’, an ‘electroblotting transfer cassette’ or a ‘transfer cassette’.

As described above, in some cases, at least a region of one or each of the first and second support panels may have an interlocking pattern of polygonal apertures. Such apertures may otherwise be referred to simply as polygons. Similarly, the interlocking pattern may otherwise be described as a tessellating pattern, a pseudo-tessellating pattern or pattern in which the apertures interlock. At least some of the interlocking patterns are patterns in which the centres of the apertures are offset with respect to adjacent apertures over rows and/or columns of apertures.

Any apertures disclosed herein may be defined by a network or framework of walls, wherein each respective wall separates an aperture from an adjacent aperture.

The apertures may form a regular pattern.

### BRIEF DESCRIPTION OF FIGURES

Specific embodiments are described below by way of example only and with reference to the accompanying drawings, in which:

FIG. 1a shows a membrane transfer cassette according to the present disclosure;

FIG. 1b shows a different view of the membrane transfer cassette of FIG. 1a;

FIG. 2 shows a support panel of a membrane transfer cassette according to the present disclosure;

FIG. 3 shows another support panel of a membrane transfer cassette according to the present disclosure;

FIG. 4a shows a hinged clip for securing together two panels of a membrane transfer cassette according to the present disclosure;

FIG. 4b shows an alternate view of the clip shown in FIG. 4a;

FIG. 5 shows another support panel of a membrane transfer cassette according to the present disclosure;

FIG. 6a shows another support panel of a membrane transfer cassette according to the present disclosure;

FIGS. 6b and 6c show alternative views of the support panel of FIG. 6a;

FIG. 7 shows another support panel of a membrane transfer cassette according to the present disclosure;

FIG. 8a shows another support panel of a membrane transfer cassette according to the present disclosure;

FIG. 8b shows an alternative view of the support panel of FIG. 8a;

FIG. 9a shows another support panel of a membrane transfer cassette according to the present disclosure;

FIG. 9b shows an alternative view of the support panel of FIG. 9a;

FIG. 10a shows another support panel of a membrane transfer cassette according to the present disclosure;

FIG. 10b shows an alternative view of the support panel of FIG. 10a; and

FIG. 11 shows a cross-sectional view of an electroblotting kit according to the present disclosure.

### DETAILED DESCRIPTION

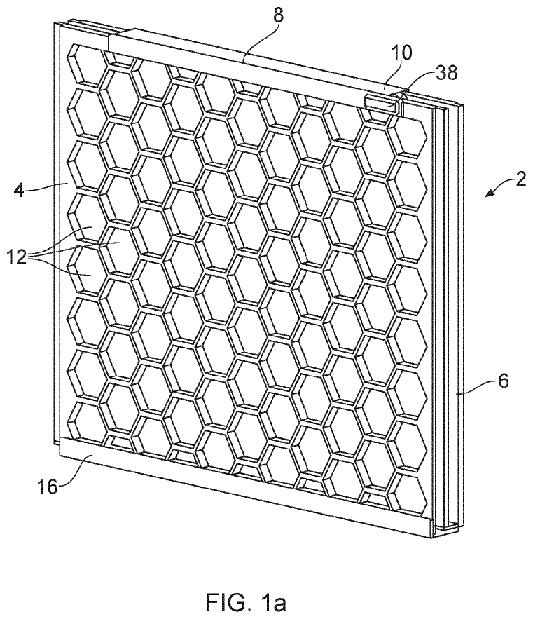

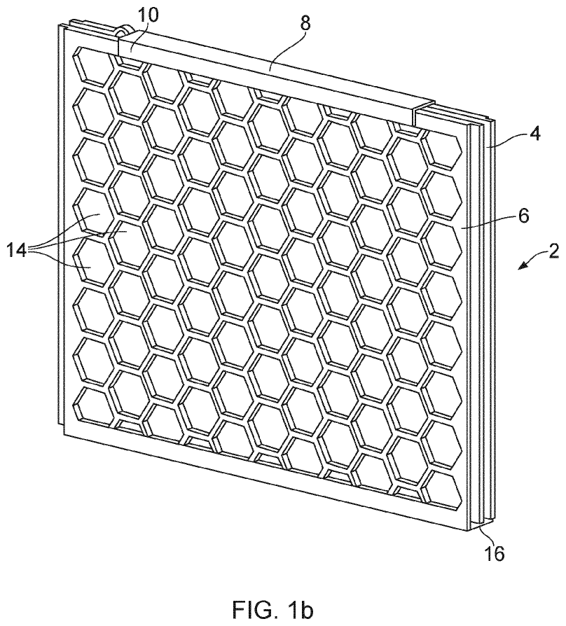

FIG. 1a shows a membrane transfer cassette 2 comprising a first support panel 4 and a second support panel 6. In use, the elements of the blotting sandwich are disposed between the first and second support panels. The membrane transfer cassette 2 further comprises a hinged clip 8 which, in use, secures the first support panel 4 to the second support panel 6, thus holding together the elements of the blotting sandwich. The hinged clip 8 is attached to the first support panel 4 by a hinge at a first end 10 of the clip and in use, fits over an edge of the first and second support panels and the blotting sandwich to secure them together. The hinged clip 8 comprises a raised portion 38 to strengthen the clip at the hinge.

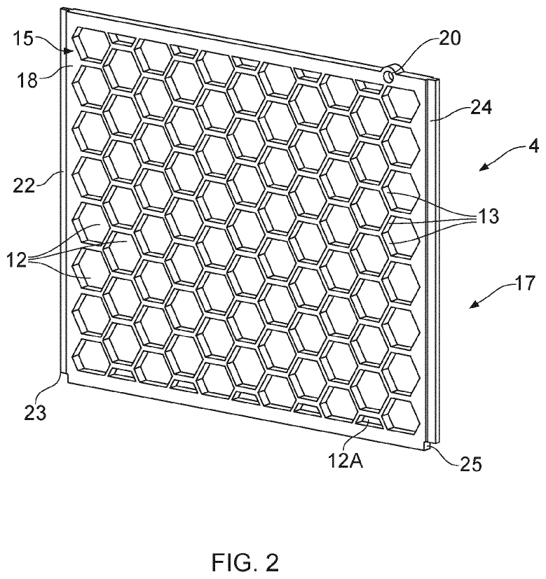

The first support panel 4 comprises a plurality of apertures 12, three of which are labelled in FIG. 1a. These apertures will be discussed in more detail with reference to FIG. 2.

As is shown in FIG. 1b, the second support panel comprises a plurality of apertures 14, three of which are labelled in FIG. 1b.

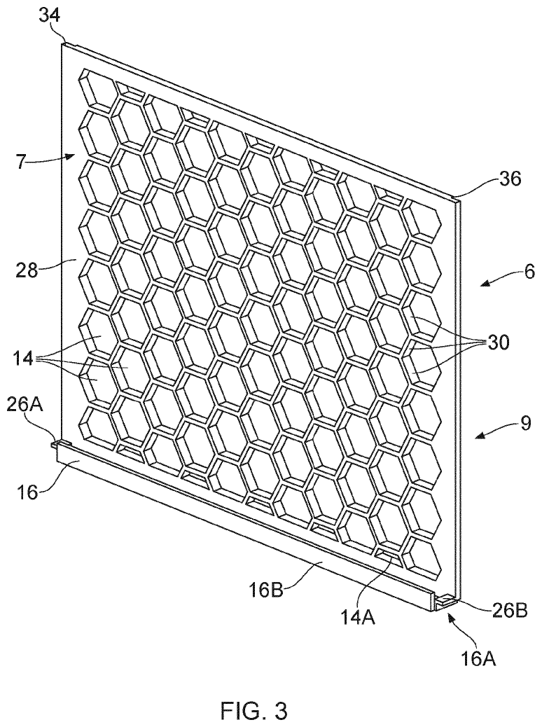

As can be most clearly seen in FIG. 1a, the second support panel 6 comprises an integral clip 16 which, in use, receives the blotting sandwich and the first support panel 4 and, along with the hinged clip 8, holds together the first and second support panels and the blotting sandwich. The integral clip will be discussed in more detail with reference to FIG. 3.

With reference to FIG. 2, the first support panel 4 comprises an outer frame 18 and a plurality of apertures 12, three of which are labelled in FIG. 2. The apertures 12 are each hexagonal and interlock to form a honeycomb pattern. This pattern spans the full height and width of the first support panel, aside from the outer frame 18, in order to expose the separating matrix to the current as far as possible while still providing enough strength to hold the blotting sandwich together to facilitate good contact between the separating matrix and membrane. A typical width (in the plane of the support panel) of the outer frame is 9 mm at the top and bottom of the support panel. Any high molecular weight macromolecules (which may not have migrated far during electrophoresis and may be present at the top of the separating matrix) may be blocked from transferring by the outer frame. Accordingly, by making the outer frame relatively narrow (in the plane of the support panel) blocking of any such high molecular weight macromolecules by the outer frame can be avoided.

The width of the outer frame at the sides of the support panel shown in FIG. 2 is different at different points along the sides due to the shape of the apertures adjacent to the outer frame. The width of the outer frame may typically range from 11 mm at its narrowest points to 18 mm at its widest points. As with the top and bottom edges of the support panel, some macromolecules (e.g. proteins) may be blocked by the outer frame at the side edges of the support panel and so providing a narrow outer frame at the side edges of the panel is also beneficial.

The apertures 12 are separated by a plurality of walls 13, three of which are labelled in FIG. 2. Specifically, each aperture 12 is separated from each adjacent aperture by a respective wall 13. The walls are typically 3 mm or 3.5 mm wide (in the plane of the support panel) and 5 mm thick (in the direction perpendicular to the plane of the support panel). At the upper and lower edges of the first support panel 4 (i.e. the upper and lower edges of the support panel when the membrane transfer cassette is in use), some of the apertures 12 are partial apertures. For example, aperture 12A is a partial hexagon. This use of partial apertures increases the exposure of the separating matrix at the edges of the first support panel 4.

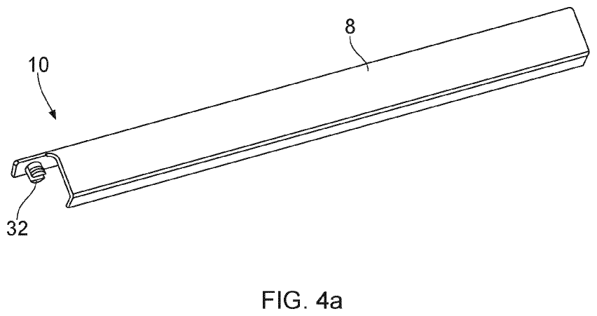

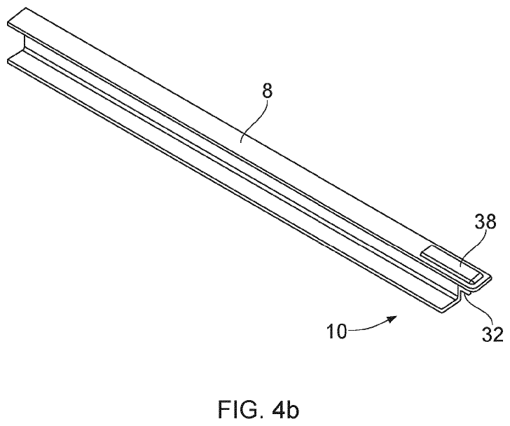

The first support panel 4 comprises a connecting aperture 20 for receiving a corresponding protrusion on the hinged clip 8 (see FIGS. 1a, 1b and 4a and 4b). This allows the clip 8 to be hingedly attached to the first support panel 4. The connecting aperture 20 is disposed at an upper edge of the support panel (upper here being defined as the uppermost edge when the membrane transfer cassette is in use).

The first support panel 4 also comprises grooves 22 and 24. These grooves are regions of reduced thickness along each of the side edges of the support panel 4.

The side edges here are defined as the edges either side of the upper edge referred to above. These grooves are present to facilitate the use of otherwise thicker support panels in a given transfer tank which is configured to receive a cassette (including the blotting sandwich) of a given thickness. By reducing the thickness of the support panels 4 and 6 at the side edges, the rest of the support panels can be made thicker than they otherwise could be, whilst still ensuring that the cassette will fit into the slot in the transfer tank. This increased thickness makes the support panels stronger and reduces bowing.

In general, a thicker support panel is preferable for increased strength but the thickness of the support panels will be limited by the thickness that will be accepted by the transfer tank.

The first support panel 4 also comprises notches 23 and 25, one at each bottom corner of the support panel. These notches interlock with the retaining elements 26A and 26B of the second support panel (see FIG. 3). These will be described below.

The first support panel 4 comprises an inner surface 17 which, in use, faces and is in contact with the blotting sandwich. The first support panel 4 also comprises an outer surface 15 which, in use, faces away from the blotting sandwich.

With reference to FIG. 3, the second support panel 6 comprises an outer frame 28 and a plurality of apertures 14, three of which are labelled in FIG. 3. As in the first support panel 4, the apertures 14 are each hexagonal and interlock to form a honeycomb pattern. The apertures 14 are separated by a plurality of walls 30, three of which are labelled in FIG. 3. Specifically, each aperture is separated from each adjacent aperture by a respective wall. The walls are typically 3 mm or 3.5 mm wide (in the plane of the support panel) and 5 mm thick (in the direction perpendicular to the support panel). As in the first support panel, the apertures 14 span substantially all of the height and width of the second support panel 6 in order to maximise the exposure of the separating matrix. At the upper and lower edges of the second support panel 6 (i.e. the upper and lower edges of the support panel when the membrane transfer cassette is in use), some of the apertures 14 are partial apertures. For example, aperture 14A is a partial hexagon. This use of partial apertures increases the exposure of the separating matrix at the edges of the second support panel 6. The dimensions of the outer frame are the same as those of the support panel shown in FIG. 2. It will be appreciated that this may not be the case however, and the dimensions of the first and second support panels may differ.

The second support panel 6 comprises an integral clip 16 disposed along the bottom edge of the second support panel. The bottom edge is defined as the lowermost edge of the support panel during use. The integral clip comprises a first portion 16A which extends perpendicular to the plane of the second support panel and a second portion 16B which extends parallel to the plane of the second support panel 6, facing the second support panel. The integral clip 16 spans the full width of the bottom edge of the second support panel. At each end of the integral clip 16 there is a respective retaining element 26A and 26B. The retaining elements extend perpendicular to the integral clip and face each other. The retaining elements help to align the first and second support panels and the blotting sandwich therebetween. The retaining elements 26A and 26B also interlock with notches 23 and 25 on the first support panel 4 (see FIG. 2). This interlocking prevents relative lateral movement between the first and second support panels once the first support panel 4 and blotting sandwich are received in the integral clip 16. This prevention of relative lateral movement is particularly useful when the user is closing the hinged clip 8.

The second support panel 6 also comprises two grooves 34 and 36, one along each side edge of the second support panel 6. These are arranged in the same way as grooves 22 and 24 on the first support panel 4 and for the same reason. The grooves can also be seen in FIG. 1b.

The second support panel 6 comprises an inner surface 7 which, in use, faces and is in contact with the blotting sandwich. The second support panel 6 also comprises an outer surface 9 which, in use, faces away from the blotting sandwich.

Whilst apertures 12 and 14 are polygonal it should be noted that they could instead have shapes which are not polygons.

With reference to FIGS. 4a and 4b, the membrane transfer cassette 2 comprises a hinged clip 8. The cross-section of the clip is a U-shape so as to fit over the first support panel 4, the blotting sandwich, and the second support panel 6. At a first end 10 of the clip, the clip 8 comprises a protrusion 32 configured to engage with the connecting aperture 20 on the first support panel 4 (see FIG. 2). The clip 8 comprises a raised portion 38 (shown in FIG. 4b) at the first end 10 of the clip to strengthen the clip.

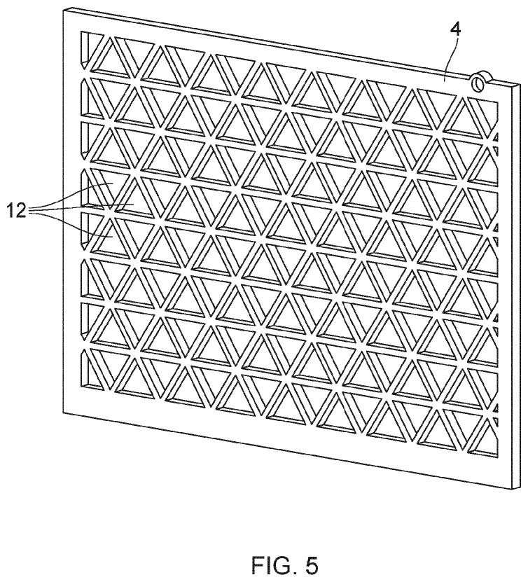

FIG. 5 shows an alternative configuration of the first support panel 4. With reference to FIG. 5, the first support panel 4 comprises apertures 12 (three of which are labelled in FIG. 5) which are triangular and arranged in an interlocking pattern. The second support panel 6 may also have this configuration of apertures or may have a different configuration.

Multiple, different shapes of aperture could also be used on one of both of the first and second support panels 4 and 6. For example, the apertures 12 and/or 14 could comprise two or more of: triangles, rectangles, squares, pentagons and hexagons.

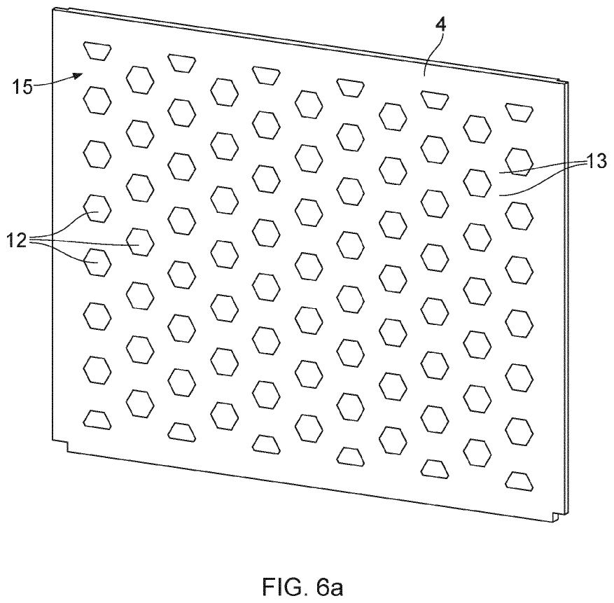

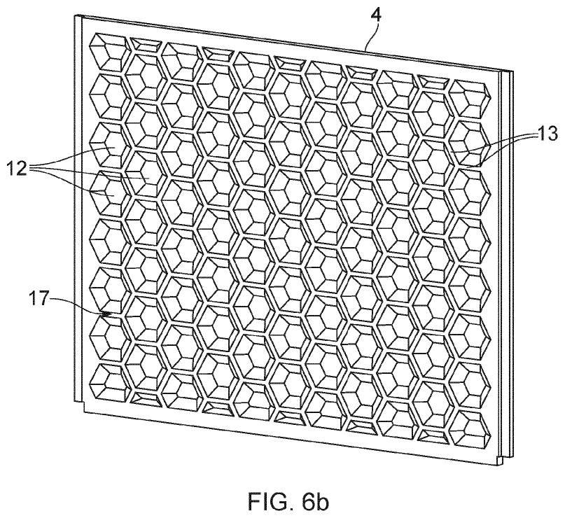

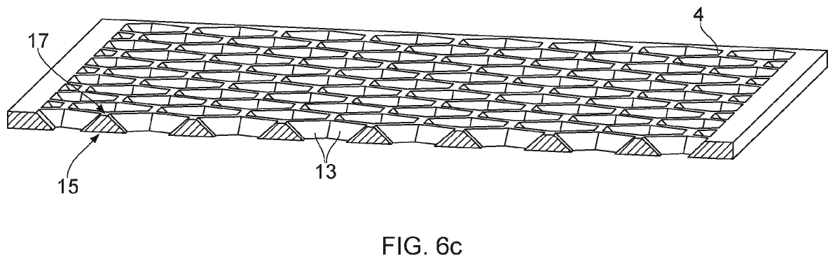

FIGS. 6a to c show an alternative configuration of the first support panel 4. With reference to FIGS. 6a to c, the walls 13 of the first support panel 4 (two of which are labelled in FIGS. 6a, b and c) have a surface area on an inner side 17 of the support panel which is smaller than a surface area of the wall on the outer side 15 of the support panel. FIG. 6a shows an outer surface 15 of the support panel which, in use, faces away from the blotting sandwich. FIG. 6b shows the inner surface 17 of the support panel shown in FIG. 6a, which in use faces and is in contact with the blotting sandwich. On the inner surface 17, the walls 13 between the apertures 12 have a surface area which is smaller than the surface area of the walls 13 on the outer surface 15 of the support panel. In this way, the outer surface 15 provides strength to the support panel and the inner surface 17, where the surface areas of the walls 13 is smaller, reduces the contact area between the support panel and the blotting sandwich.

FIG. 6c shows a cross-sectional view of the support panel of FIGS. 6a and 6b. The cross-section of each of the walls is a trapezium.

FIGS. 6a to c show the first support panel having walls shaped in this way but the second support panel could equally have walls of this shape (with a surface area which is greater on an outer surface of the support panel than on an inner surface). One or both of the first and second support panels may have walls shaped in this way.

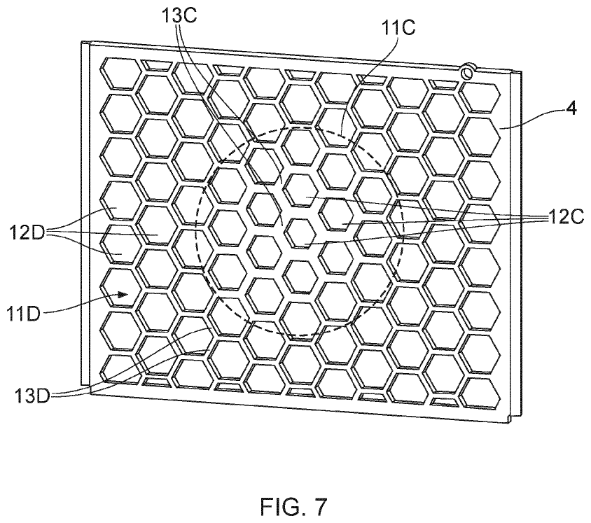

FIG. 7 shows an alternative configuration of the first support panel 4. With reference to FIG. 7, the first support panel 4 comprises apertures of different sizes. Specifically, the first support panel 4 comprises a central region (ringed with a dashed line and labelled 11C) and an outer region 11D (i.e. the region outside of the ringed portion 11C), with the central region 11C having apertures 12C which are smaller than those in the outer region 11D (apertures 12D). The walls 13C of the apertures in the central region 11C are also thicker (in the plane of the support panel) than those between the apertures in the outer region 11D (walls 13D). Only a subset of the walls and apertures are labelled in FIG. 7 for clarity. These features described with reference to FIG. 7 may also equally be applied to the second support panel 6. One or both of the first and second support panels may have the features described with reference to FIG. 7.

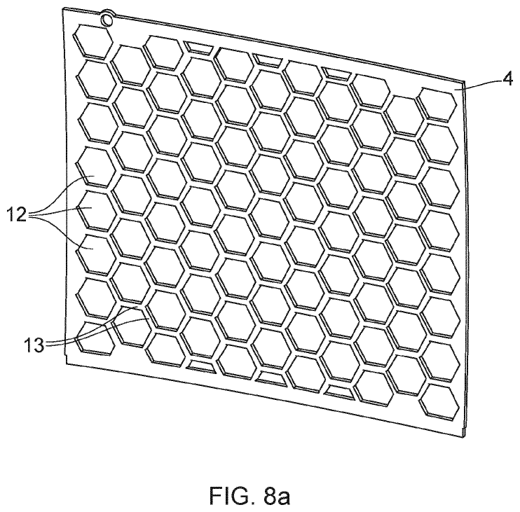

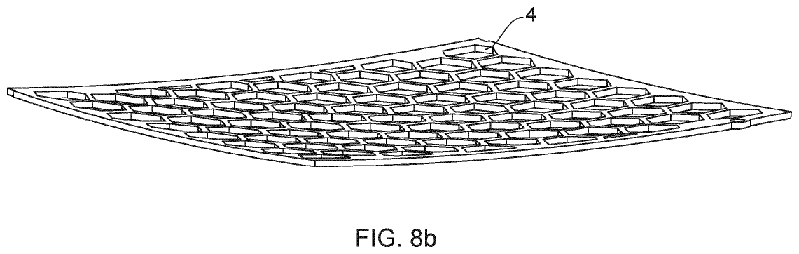

FIGS. 8a and 8b show an alternative configuration of the first support panel 4. With reference to FIGS. 8a and 8b, the first support panel 4 is bowed. Specifically, it is curved such that in the absence of the blotting sandwich, when the inner surfaces of the first and second support panels face each other, a distance between the centre of the first support panel 4 and the centre of the second support panel 6 is less than a distance between the first and second support panels at an edge of the support panels. As described above, the result of this bowing is that in use, the pressure exerted by the membrane transfer cassette on the blotting sandwich is more uniform over the plane of the membrane transfer cassette. This is because the bowing compensates for the reduced strength of the support panel at the centre as compared to the edges. It will be appreciated that one or both of the first and second support panels may be bowed in this way.

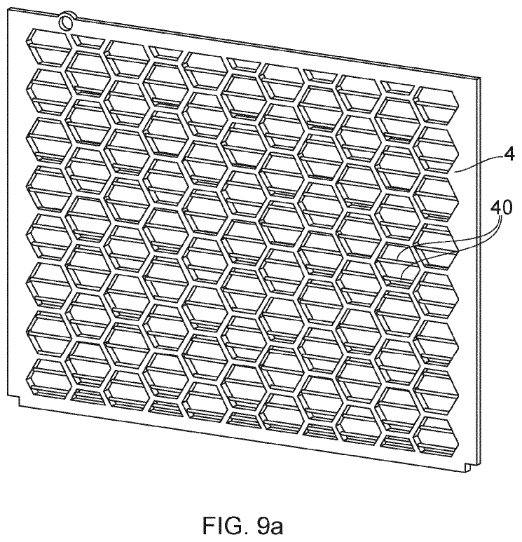

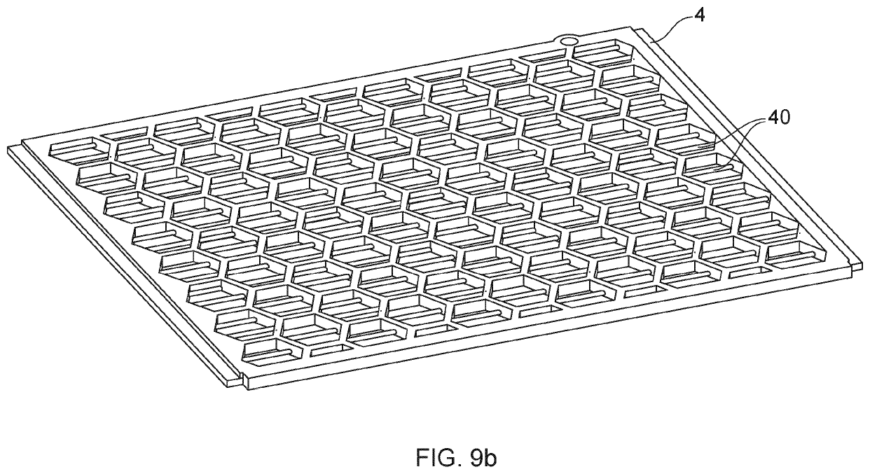

FIGS. 9a and 9b show an alternative configuration of the first support panel 4. With reference to FIGS. 9a and 9b, the first support panel 4 comprises a plurality of support rods 40 (two of which are labelled in FIGS. 9a and b) to strengthen the support panel. The support rods span the width of the first support panel and are thinner (in a direction perpendicular to the plane of the panel) than the support panel itself such that in use, the support rods 40 do not come into contact with the blotting sandwich. In this way, the rods strengthen the support panel but do not increase the surface area of the panel which contacts the blotting sandwich during use. The support rods may equally have a different configuration (for example they could run from the top to the bottom of the support panel as opposed to from one side to the other). The support rods may not necessarily be parallel but could overlap, for example one set of support rods may run perpendicular to another set.

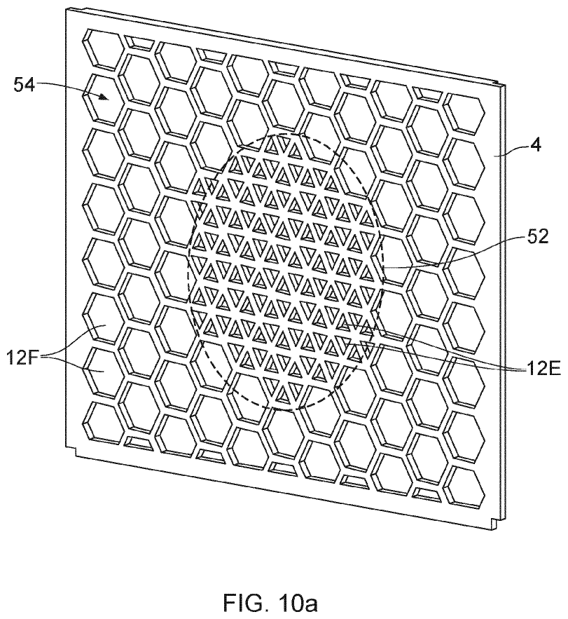

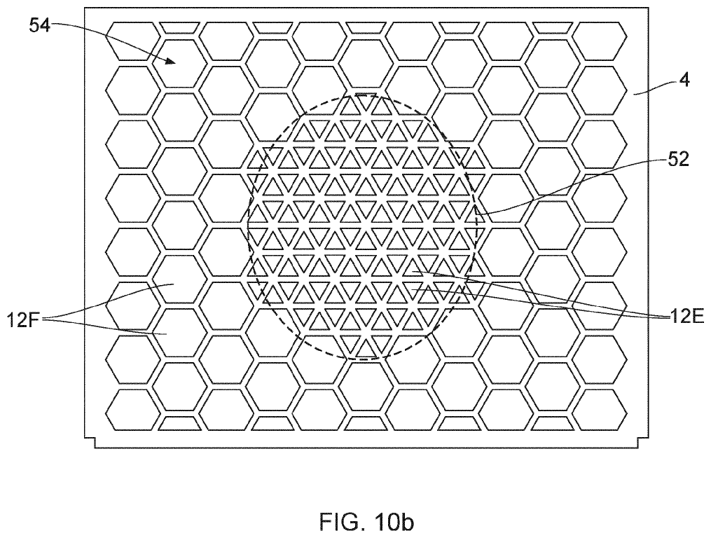

FIGS. 10a and 10b show a further configuration of the first support panel 4. With reference to FIG. 10a, the first support panel 4 comprises apertures of two different shapes. Specifically, the first support panel 4 comprises a first region 52 (shown ringed in FIGS. 10a and 10b) which comprises a plurality of triangular apertures 12E (two of which are labelled in FIGS. 10a and 10b for clarity). Each triangular aperture is rotated by 180° with respect to each adjacent triangular aperture so that they form an interlocking pattern.

The first support panel 4 also comprises a second region 54 which comprises hexagonal apertures 12F, two of which are labelled in FIGS. 10a and 10b for clarity. The hexagonal apertures 12F are arranged in a honeycomb pattern. The hexagonal apertures 12F are larger than the triangular apertures 12E. The difference in shape and size as between the apertures 12E and 12F means that the support panel is stronger in the first region 52 (comprising the smaller, triangular apertures 12E) but exposes a greater proportion of the membrane (thus facilitating better transfer of the macromolecules onto the membrane during use) in the second region 54. In this way, the size and shape of apertures in different regions of a support panel can be selected to control the characteristics (such as strength and percentage exposure of the membrane in use) of the support panel in those regions.

FIGS. 10a and 10b show a support panel having two regions wherein the apertures in one region are of a different shape and size to the apertures in the other region but it will be appreciated that the apertures in the two regions could be of the same or comparable size but have different shapes. For example, the triangular apertures 12E could be of the same or comparable size to the hexagonal apertures 12F. Equally, the apertures in the two regions could all be of the same shape but be of different sizes (for example as shown in FIG. 7), with the apertures in one region being a different size to the apertures in the other region. It will be appreciated that the features described with reference to FIGS. 10a and 10b could additionally or alternatively be applied to the second support panel 6.

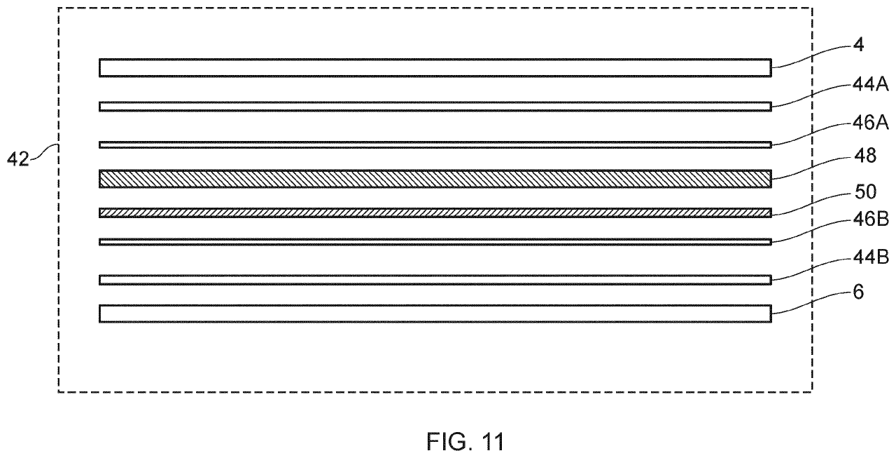

FIG. 11 shows a cross-sectional view of an electroblotting kit 42 comprising the following:
a first support panel 4
a sponge 44A
a piece of filter paper 46A
a separating matrix (gel) 48
a membrane 50
a piece of filter paper 46B
a sponge 44B and
a second support panel 6.

The elements of FIG. 11 are shown stacked in the order that they would be in use but are shown spaced apart for clarity.

Any membrane transfer cassette disclosed herein or a part of it may be made of a material that can tolerate immersion in buffer containing alcohol, being exposed to high voltages (up to 400V) and high temperatures (up to 60° C.). An example of such a material is polyamide 12. Other types of plastic, such as Nylon, could also be used. The cassette could also be made of metal.

Reference is made herein to polygons and polygonal shapes. It will be appreciated that this is intended to refer to polygons which may have rounded corners or slightly curved edges but which are generally polygonal in shape.

Various aspects and embodiments of the present invention provide numerous advantages, e.g. when compared to known systems currently used for small gel electrophoresis. Such embodiments may, for example, be used in a wider size and shape range and can provide for increased supporting strength at larger sizes. Poor supporting strength of the gel and a membrane sandwich during electroblotting of large gels in conventional systems is known to give poor results (i.e. poor resolution). Additionally, in various conventional devices where an amount of supporting material used is relatively great (i.e. with a high surface area) current blocking and protein transfer blocking in the support areas can also occur. Certain embodiments of the present invention may thus be provided in order to address such issues.

The singular terms “a” and “an” should not be taken to mean “one and only one”. Rather, they should be taken to mean “at least one” or “one or more” unless stated otherwise. The word “comprising” and its derivatives including “comprises” and “comprise” include each of the stated features, but does not exclude the inclusion of one or more further features.

The above implementations have been described by way of example only, and the described implementations are to be considered in all respects only as illustrative and not restrictive. It will be appreciated that variations of the described implementations may be made without departing from the scope of the invention. It will also be apparent that there are many variations that have not been described, but that fall within the scope of the appended claims.

Reference signs relating to the features shown in the drawings have been placed in parentheses in the claims to increase their intelligibility. These reference signs should not be construed as limiting the claim.

Also disclosed is the following:
1. A membrane transfer cassette for electroblotting, the cassette comprising a first support panel and a second support panel, at least a region of one or each of the first and second support panels having an interlocking pattern of polygonal apertures.
2. A membrane transfer cassette according to item 1, wherein each of the polygonal apertures has 3 sides or 5 or more sides.
3. A membrane transfer cassette according to item 1 or 2, wherein the polygonal apertures comprise apertures having two or more shapes.
4. A membrane transfer cassette according to item 1 or 2, wherein each of the polygonal apertures is the same shape.
5. A membrane transfer cassette according to any preceding item wherein the polygonal apertures comprise apertures of two or more sizes.
6. A membrane transfer cassette according to item 1, wherein each of the polygonal apertures is a hexagon and the interlocking pattern is a honeycomb pattern.
7. A membrane transfer cassette according to any preceding item wherein:
   the first support panel has an inner surface and an outer surface; and
   the second support panel has an inner surface and an outer surface;
   wherein, in use, the inner surface of the first support panel faces the inner surface of the second support panel;
   wherein each polygonal aperture is separated from each adjacent aperture by a respective wall;
   wherein one or more of the walls has a surface area on the outer surface of the support panel which is greater than a surface area of the wall on the inner surface of the support panel.
8. A membrane transfer cassette according to any preceding item wherein the region is a central region of the respective support panel and the respective support panel further comprises an outer region having apertures, wherein the apertures in the outer region differ in one or more of shape, size or pattern to the polygonal apertures in the central region.
9. A membrane transfer cassette according to any of items 1 to 7 wherein the region is an outer region of the respective support panel and the respective support panel further comprises a central region having apertures, wherein the apertures in the central region differ in one or more of shape, size or pattern to the polygonal apertures in the outer region.
10. A membrane transfer cassette according to item 8 or 9, wherein the apertures in the central region are smaller than the apertures in the outer region.
11. A membrane transfer cassette according to any of items 8 to 10, wherein the apertures in the central region are hexagons and form a honeycomb pattern.
12. A membrane transfer cassette according to any preceding item, wherein one or each of the first and second support panels is bowed.
13. A membrane transfer cassette according to any preceding item, wherein one of the first and second support panels is flat and the other support panel comprises a connecting mechanism for connecting the first and second support panels together.
14. A membrane transfer cassette according to item 13, wherein the connecting mechanism is a hinged clip for connecting the first and second support panels together, wherein the hinged clip is arranged at an edge of the support panel and wherein the length of the hinged clip is 60% or more or preferably 70% or more of the length of the edge of the panel.
15. A membrane transfer cassette according to any preceding item, wherein the percentage of the surface area of the first and/or second support panels which is taken up by apertures is between 55% and 75% or preferably between 65% and 75%.
16. A membrane transfer cassette according to any preceding item, wherein one of the first and second support panels comprises an integral clip at an edge of the support panel, wherein the integral clip is integral to the support panel and is arranged to receive the other support panel.
17. A membrane transfer cassette according to item 16, wherein the integral clip is as long as the length of the edge of the panel.
18. A support panel for a membrane transfer cassette for electroblotting, at least a region of the support panel having an interlocking pattern of polygonal apertures.
19. A computer-aided design file comprising a digital representation of the support panel of item 18 or the membrane transfer cassette of any of items 1 to 17, wherein the computer-aided design file is readable by an additive manufacturing device such as a 3D printer for the device to produce the components of the membrane transfer cassette or support panel by additive manufacture.
20. An electroblotting kit, the kit comprising at least a membrane transfer cassette according to any of items 1 to 17 and one or more elements of an electroblotting sandwich.
21. A method of electroblotting comprising using a membrane transfer cassette according to any of items 1 to 17.

1. A membrane transfer cassette for electroblotting, the cassette comprising a first support panel and a second support panel, at least a region of one or each of the first and second support panels having an interlocking pattern of polygonal apertures wherein the polygonal apertures have 3 sides or 5 or more sides.

2. A membrane transfer cassette according to claim 1, wherein each of the polygonal apertures has 6 or more sides.

3. A membrane transfer cassette according to claim 1, wherein the polygonal apertures comprise apertures having two or more shapes.

4. A membrane transfer cassette according to claim 1, wherein each of the polygonal apertures is the same shape.

5. A membrane transfer cassette according to say preceding-claim claim 1, wherein the polygonal apertures comprise apertures of two or more sizes.

6. A membrane transfer cassette according to claim 1, wherein each of the polygonal apertures is a hexagon and the interlocking pattern is a honeycomb pattern.

7. A membrane transfer cassette according to claim 1, wherein:
the first support panel has an inner surface and an outer surface; and
the second support panel has an inner surface and an outer surface;
wherein, in use, the inner surface of the first support panel faces the inner surface of the second support panel;
wherein each polygonal aperture is separated from each adjacent aperture by a respective wall;
wherein one or more of the walls has a surface area on the outer surface of the support panel which is greater than a surface area of the wall on the inner surface of the support panel.

8. A membrane transfer cassette according to claim 1, wherein the region is a central region of the respective support panel and the respective support panel further comprises an outer region having apertures, wherein the apertures in the outer region differ in one or more of shape, size or pattern to the polygonal apertures in the central region.

9. A membrane transfer cassette according to claim 1, wherein the region is an outer region of the respective support panel and the respective support panel further comprises a central region having apertures, wherein the apertures in the central region differ in one or more of shape, size or pattern to the polygonal apertures in the outer region.

10. A membrane transfer cassette according to claim 8, wherein the apertures in the central region are smaller than the apertures in the outer region.

11. A membrane transfer cassette according to claim 8, wherein the apertures in the central region are hexagons and form a honeycomb pattern.

12. A membrane transfer cassette for use in electroblotting, the cassette comprising:
a first support panel having an inner surface and an outer surface; and
a second support panel having an inner surface and an outer surface;
wherein, in use, the inner surface of the first support panel faces the inner surface of the second support panel;
wherein one or each of the first and second support panels has a set of apertures, each aperture separated from each adjacent aperture by a respective wall,
wherein one or more of the walls has a surface area on the outer surface of the support panel which is greater than a surface area of the wall on the inner surface of the support panel.

13. A membrane transfer cassette according to claim 12, wherein at least some of the set of apertures are polygonal apertures which form an interlocking pattern.

14. A membrane transfer cassette according to claim 12, wherein the set of apertures comprises apertures of two or more shapes.

15. A membrane transfer cassette according to claim 12, wherein each of the apertures is the same shape.

16. A membrane transfer cassette according to claim 12, wherein the set of apertures comprises apertures of two or more sizes.

17. A membrane transfer cassette according to claim 13, wherein each of the polygonal apertures has 3 sides or 5 or more sides.

18. A membrane transfer cassette according to claim 13, wherein each of the polygonal apertures is a hexagon and the interlocking pattern is a honeycomb pattern.

19. A membrane transfer cassette according to claim 12, wherein one or each of the first and second support panels comprises a central region comprising an inner plurality of apertures and an outer region comprising an outer plurality of apertures, wherein the set of apertures comprises at least some of the inner and/or outer plurality of apertures,
wherein the apertures of the inner plurality of apertures differ in one or more of shape, size or pattern to the apertures of the outer plurality of apertures.

20. A membrane transfer cassette for use in electroblotting, the cassette comprising:
a first support panel; and
a second support panel;
wherein one or each of the first and second panels comprises a central region having an inner plurality of apertures and an outer region having an outer plurality of apertures,
wherein the apertures of the inner plurality of apertures differ in one or more of shape, size or pattern to the apertures of the outer plurality of apertures.

21. A membrane transfer cassette 24 according to claim 19, wherein the apertures in the inner plurality of apertures are smaller than the apertures in the outer plurality of apertures.

22. A membrane transfer cassette according to claim 19, wherein the inner and/or outer plurality of apertures each comprise apertures of two or more different shapes and/or sizes.

23. A membrane transfer cassette according to claim 19, wherein each of the inner plurality of apertures and/or each of the outer plurality of apertures is the same shape.

24. A membrane transfer cassette according to claim 19, wherein each of the apertures in the inner and/or outer plurality of apertures are hexagons and form a honeycomb pattern.

25. A membrane transfer cassette according to claim 19, wherein at least some of the inner and/or outer plurality of apertures are polygonal and form an interlocking pattern.

26. A membrane transfer cassette according to claim 25, wherein each of the polygonal apertures has 3 sides or 5 or more sides.

27. A membrane transfer cassette according to claim 25, wherein each of the polygonal apertures is a hexagon and the interlocking pattern is a honeycomb pattern.

28. A membrane transfer cassette according to claim 19, wherein the first support panel has an inner surface and an outer surface, and the second support panel has an inner surface and an outer surface, wherein, in use, the inner surface of the first support panel faces the inner surface of the second support panel,
wherein each aperture is separated from each adjacent aperture by a respective wall; and
wherein one or more of the walls has a surface area on the outer surface of the support panel which is greater than a surface area of the wall on the inner surface of the support panel.

29. A membrane transfer cassette according to claim 1, wherein one or each of the first and second support panels is bowed.

30. A membrane transfer cassette for electroblotting, the cassette comprising a first support panel and a second support panel, at least a region of one or each of the first and second support panels having a plurality of apertures, wherein one or each of the first and second support panels is bowed.

31. A membrane transfer cassette according to claim 30, wherein the apertures are polygonal and form an interlocking pattern.

32. A membrane transfer cassette according to claim 31, wherein each of the polygonal apertures has 3 sides or 5 or more sides.

33. A membrane transfer cassette according to claim 30, wherein the plurality of apertures comprise apertures having two or more shapes.

34. A membrane transfer cassette according to claim 20, wherein each of the apertures is the same shape.

35. A membrane transfer cassette according to claim 30, wherein the plurality of apertures comprises apertures of two or more sizes.

36. A membrane transfer cassette according to claim 31, wherein each of the polygonal apertures is a hexagon and the interlocking pattern is a honeycomb pattern.

37. A membrane transfer cassette according to claim 30, wherein:
the first support panel has an inner surface, and an outer surface; and
the second support panel has an inner surface and an outer surface;
wherein, in use, the inner surface of the first support panel faces the inner surface of the second support panel;
wherein each aperture is separated from each adjacent aperture by a respective wall;
wherein one or more of the walls has a surface area on the outer surface of the support panel which is greater than a surface area of the wall on the inner surface of the support panel.

38. A membrane transfer cassette according to claim 30, wherein the region is a central region of the respective support panel and the respective support panel further comprises an outer region having apertures, wherein the apertures in the outer region differ in one or more of shape, size or pattern to the apertures in the central region.

39. A membrane transfer cassette according to claim 30, wherein the region is an outer region of the respective support panel and the respective support panel further comprises a central region having apertures, wherein the apertures in the central region differ in one or more of shape, size or pattern to the apertures in the outer region.

40. A membrane transfer cassette according to claim 38, wherein the apertures in the central region are smaller than the apertures in the outer region.

41. A membrane transfer cassette according to claim 38, wherein the apertures in the central region are hexagons and form a honeycomb pattern.

42. A membrane transfer cassette according to claim 1, wherein one of the first and second support panels is flat and the other support panel comprises a connecting mechanism for connecting the first and second support panels together.

43. A membrane transfer cassette according to claim 42, wherein the connecting mechanism is a hinged clip for connecting the first and second support panels together, wherein the hinged clip is arranged at an edge of the support panel and wherein the length of the hinged clip is 60% or more or preferably 70% or more of the length of the edge of the panel.

44. A membrane transfer cassette according to claim 1, wherein the percentage of the surface area of the first and/or second support panels which is taken up by apertures is between 55% and 75% or preferably between 65% and 75%.

45. A membrane transfer cassette according to claim 1, wherein one of the first and second support panels comprises an integral clip at an edge of the support panel, wherein the integral clip is integral to the support panel and is arranged to receive the other support panel.

46. A membrane transfer cassette according to claim 45, wherein the integral clip is as long as the length of the edge of the panel.

47. A support panel for a membrane transfer cassette for electroblotting, at least a region of the support panel having an interlocking pattern of polygonal apertures.
